(19) United States
(12) Patent Application Publication
(10) Pub. No.: US 2012/0054672 A1
(43) Pub. Date: Mar. 1, 2012

(54) Speed Reading and Reading Comprehension Systems for Electronic Devices

(75) Inventor: Mark E. McDowell, Cornelius, NC (US)

(73) Assignee: ACTA CONSULTING, Cornelius, NC (US)

(21) Appl. No.: 12/873,787

(22) Filed: Sep. 1, 2010

(51) Int. Cl. G06F 3/048

(52) U.S. Cl. 715/784; 715/803

(57) ABSTRACT

Speed reading and reading comprehension capabilities are provided on an electronic device for one or more users. A method involves accessing reading material including text on the electronic device, accessing a graphical user interface to present the reading material, determining a number of lines of text to present within a windowed area within the graphical user interface, and presenting the reading material in the graphical user interface. An area in the graphical user interface that is located outside of the windowed area is grayed, shaded or partially obscured, and the text is presented both within the windowed area and outside of the windowed area. Statistics can be presented for at least assessing a reading rate of the user, comparing two or more reading rates of the user over different time intervals, or comparing a reading rate of the user with a reading rate of another user.

### TECHNICAL FIELD

This disclosure relates to techniques for employing speed reading and reading comprehension concepts on electronic devices.

### BACKGROUND

Speed reading concepts generally involve methods for a human reader to read material at faster rates without reducing their comprehension or retention. Techniques for speed reading can involve practicing one's reading rate and ability for a type of content and keeping track of one's reading rate over time to see if their reading rate has increased over time.

### SUMMARY

This specification describes technologies generally relating to techniques for employing speed reading and reading comprehension concepts on electronic devices.

In general, some aspects of the subject matter described in this specification can be embodied in methods that involve software that can be employed in an electronic device, such as a mobile device (e.g., cell phone, an electronic-reader, a reading tablet) or a computer with a display, where users of the electronic device can practice speed reading and reading comprehension techniques. Other embodiments of this aspect include corresponding systems, apparatus, and computer programs, configured to perform the actions of the methods, encoded on computer storage devices.

In general, another aspect of the subject matter described in this specification can be embodied in methods that include the actions related to a method for providing speed reading or reading comprehension capabilities on an electronic device for one or more users. A method includes accessing reading material having text on the electronic device, where the electronic device includes a display. The method involves accessing a graphical user interface to present the reading material, determining a number of lines of text to present within a windowed area within the graphical user interface, and presenting the reading material in the graphical user interface on the display of the electronic device. An area in the graphical user interface that is located outside of the windowed area is grayed, shaded or partially obscured. The text of the reading material is presented both within the windowed area and outside of the windowed area. The text within the area located outside of the windowed area is grayed, shaded or partially obscured.

These and other embodiments can each optionally include one or more of the following features. The method can involve determining a scrolling rate to present the reading material, and presenting the reading material at the determined scrolling rate. The material can be scrolled in a direction that presents one or more lines of text at a time in the windowed area. The method can involve accessing information related to the reading material. The other information can include information for at least an author of the reading material. The method can include tracking one or more user interactions related to the reading material on the electronic device, and recording the tracked one or more user interactions. The user interactions can include information for a length of time the reading material scrolls on the graphical user interface until the scrolling is stopped, a length of time the reading material scrolls on the graphical user interface before the scrolling is paused, a rate of words per minute that are presented in the graphical user interface, a number of pauses that occurs within a first time interval, and/or a number of times the scrolling of the reading material is stopped or restarted in the graphical user interface. The user interactions can include receiving instructions for a rate of words per minute to present in the graphical user interface in a second time interval, receiving instructions for a rate of words per minute to present in the windowed area in a third time interval, information for a time and a date the reading material is presented in the graphical user interface, and/or user information associated with the reading material or the electronic device. The method can involve recording information related to the user interactions, and computing statistics related to the recorded information. The method can involve storing the computed statistics on the electronic device, and sharing at least some of the computed statistics with at least a server or at least one other computer that is separate from the electronic device. The sharing can involve retrieving the stored computed statistics on the electronic device, and sending the retrieved computed statistics to at least the server or at least the one other computer. The method can include receiving a request for the computed statistics, retrieving the computed statistics on the electronic device, and presenting the computed statistics on the graphical user interface of the electronic device. The method can involve receiving a request for statistics related to speed reading and/or reading comprehension for another user who is different from a current user of the electronic device, providing the statistics related to the user in the graphical user interface, providing the statistics related to the other user in the graphical user interface, and providing a selector in the graphical user interface that, upon being selected, can be configured to present a comparison of the statistics related to the user and the other user in the graphical user interface. The number of lines of text to be presented in the windowed area is configured to be determined by at least one of a user input for the number of lines, a number of lines that is preset in a memory location in the electronic device, or a user's manipulation of a marker on the graphical user interface that is configured to adjust the number of lines in the windowed area. The method can involve presenting a word rate counter in the graphical user interface that shows a number of words per minute presented in the graphical user interface. The word rate counter can be configured to receive a user input to set the number of words per minute presented in the graphical user interface. The method can involve receiving an instruction to scroll the text in the graphical user interface in a first direction downwards towards an end of the reading material, in a second direction upwards to a beginning of the reading material, or to pause or stop scrolling the reading material in the graphical user interface. The scrolling rate can be configured to be a fixed scrolling rate or a variable scrolling rate. The scrolling rate can vary for different parts of the reading material (e.g., chapter 1 has a first reading rate, chapter 2 has a second scrolling rate, chapter 3 has a third reading rate, and so on). The scrolling rate can be determined based on an age of the user of the electronic device, a type of the reading material, a complexity of the reading material, and/or a recently-used scrolling rate. The scrolling rate can be determined based on a user-defined scrolling rate. The method can involve selecting one or more words that appear from the text within the windowed area to gray, shade, tint, deemphasize or partially obscure. The one or more grayed, shaded, tinted, deemphasized or partially obscured words can include a word that is an article (e.g., indefinite articles “a,” and “an,” or the definite article “the”), a commonly-used word in the text (e.g., a word appearing a number of times in the text greater than a threshold number), a word that has a word length exceeding a number of characters (e.g., a word that has a number of characters that is greater than a threshold amount of characters), or a word that is selected by a user to be grayed, shaded, tinted, de-emphasized or partially obscured. The method can include retrieving account information for a user, presenting the account information in the graphical user interface, and presenting information in the graphical user interface related to at least a reading rate of the user over one or more time intervals. The method can include retrieving account information for multiple users, presenting the account information in the graphical user interface, and presenting information in the graphical user interface related to at least a reading rate of the multiple users over one or more time intervals. The presented information can include at least a comparison of information for at least two of the users. The reading material can be accessed from an email.

In general, another aspect of the subject matter described in this specification can be embodied in an article having a non-transitory machine-readable medium storing instructions operable to cause a machine to perform operations for providing speed reading or reading comprehension capabilities on the machine for one or more users. The article comprises instructions for accessing reading material having text on the electronic device, where the electronic device includes a display. The article comprises instructions for accessing a graphical user interface to present the reading material, determining a number of lines of text to present within a windowed area within the graphical user interface, and presenting the reading material in the graphical user interface on the display of the electronic device. An area in the graphical user interface that is located outside of the windowed area is grayed, shaded or partially obscured. The text of the reading material is presented both within the windowed area and outside of the windowed area. The text within the area located outside of the windowed area is grayed, shaded or partially obscured.

These and other embodiments can each optionally include one or more of the following features. The article can be configured to have instructions to determine a scrolling rate to present the reading material, and present the reading material at the determined scrolling rate. The material can be scrolled in a direction that presents the determined number of lines of text in the windowed area. The article can be configured to have instructions to record information related to a user's interaction with the reading material on the graphical user interface. The recorded information can include at least an assessment related to a user's reading rate of reading the reading material. The article can be configured to have instructions to compute statistics related to the recorded information for providing at least the assessment for at least the reading rate of the user, comparing two or more reading rates of the user over different time intervals, and/or comparing at least a reading rate of the user with a reading rate of another user. The article can be configured to have instructions to present the computed statistics on the graphical user interface. The article can be configured to have instructions to store a reading profile of the user. The reading profile of the user can have at least a previously-used reading rate or a pre-defined reading rate for the user based on at least a type of reading material or an age of the user. The article can be configured to have instructions to share the reading profile with at least one other user by transmitting the reading profile of the user to an electronic device that permits the other user to access the reading profile of the user, receive a reading profile of the other user, and present information related to the reading profiles of the user and the other user on the graphical user interface.

In general, another aspect of the subject matter described in this specification can be embodied in a method for providing speed reading functionality on an electronic device for one or more users. The method includes loading reading material on the electronic device, for which the electronic device includes a display configured to present the reading material in a graphical user interface, and the reading material includes multiple lines of text. The method involves scrolling the one or more lines of text of the reading material in a direction in the graphical user interface, determining a number of words that are scrolled in the graphical user interface in a time interval, and using the determined number of words scrolled in a time interval to determine a reading rate for a reader of the reading material. The method involves presenting the reading rate for the reader in the graphical user interface, presenting one to five lines of the text in a windowed area within the graphical user interface, and shading, tinting, deemphasizing or at least partially obscuring the text that is not within the windowed area such that the text within the windowed area is more predominately displayed in the graphical user interface than the text outside of the windowed area.

These and other embodiments can each optionally include one or more of the following features. The method can involve storing the reading rate for the reader in the electronic device, where the stored reading rate can be associated with the reading material or with a type of reading material that is similar to the reading material in the graphical user interface. The type of reading material can be classified according to at least a web page, a journal article, a legal publication, a technical publication, a type of book, an email, a complexity of the reading material or an age group for readers of the reading material. The method can involve maintaining information for a user account for the reader. The user account can include one or more preferences provided by the user regarding a selected reading material, a type of reading material or a pre-defined number of words for a time interval to scroll the reading material in the graphical user interface. The user account can include information regarding a log of reading materials that have been accessed by the user, a log of one or more reading rates associated with the reading materials, and/or statistics related to the one or more reading rates associated with changes in the one or more reading rates over one or more time intervals.

In general, another aspect of the subject matter described in this specification can be embodied in a method for providing speed reading or reading comprehension capabilities on an electronic device for one or more users. The method includes accessing reading material having text on the electronic device, for which the electronic device includes a display. The method involves accessing a graphical user interface to present the reading material, determining a number of words per line of text to present within a windowed area within the graphical user interface, determining a number of lines of text to present within the windowed area within the graphical user interface, and presenting the reading material in the graphical user interface on the display of the electronic device. The windowed area is located within a framed area within the graphical user interface. An area in the graphical user interface that is located outside of the windowed area and within the framed area is grayed, shaded or partially obscured. The text of the reading material is presented within the framed area. The text of the reading material is presented within the windowed area and outside of the windowed area within the framed area, and the text within the area located outside of the windowed area and within the framed area is grayed, shaded or partially obscured.

These and other embodiments can each optionally include one or more of the following features. The reading material can be accessed from an email. The method can involve scrolling the text in the windowed area, and determining a number of words scrolled into the windowed area in a time interval. The method can involve receiving instructions for a rate to scroll the text in the windowed area. The method can involve receiving user instructions for manipulating a size of the windowed area to change the number of words per line or the number of lines of text in the windowed area, and changing the number of words per line or the number of lines of text in the windowed area corresponding to the user instructions. The user instructions can be received via one or more user interactions on a touch screen device, for which the interactions can relate to a user adjusting the size of the windowed area or a size of the framed area around the windowed area. The method can include accessing instructions for one or more words, phrases, or a string of text to gray, shade or at least partially obscure within the windowed area. A font of the one or more words, phrases, or the string of text can be grayed, shaded, deemphasized or at least partially obscured within the windowed area according to the accessed instructions. The method can involve presenting the reading material in the graphical user interface on the display of the electronic device by presenting the reading material on a tablet reading device having a touch screen that is configured to receive user instructions.

The details of one or more embodiments of the subject matter described in this specification are set forth in the accompanying drawings and the description below. Other features and aspects of the subject matter will become apparent from the description, the drawings, and the claims.

### BRIEF DESCRIPTION OF THE DRAWINGS

FIG. 1 depicts a diagram of an implementation of the speed reading and reading comprehension techniques on an electronic device.

FIG. 2 depicts a diagram of text presented on the electronic device with the implemented speed reading and reading comprehension techniques.

FIG. 3 depicts some of the options and configuration features for the speed reading and reading comprehension techniques.

FIG. 4A depicts a diagram of the electronic device when the scrolling of the text in the electronic device is paused.

FIG. 4B depicts a diagram of a windowed area in the electronic device.

FIG. 5 depicts an example of the electronic device with user settings and user account information.

FIG. 6 depicts some of options and factors that are taken into account when utilizing statistics in the electronic device.

FIG. 7 depicts an example of the electronic device where statistics are used to allow the user to record and review results of their reading rate and comprehension.

FIG. 8 depicts an example of a flow diagram for an implementation of the speed reading and reading comprehension techniques on the electronic device.

Like reference numbers and designations in the various drawings indicate like elements.

### DETAILED DESCRIPTION

Technologies are described that generally relate to techniques for employing speed reading and reading comprehension concepts on electronic devices, such as a mobile device (e.g., cell phone, an electronic-reader, a reading tablet) or a computer with a display. Some implementations employing software techniques to manipulate digital text, for example in an e-reader or browser, to allow reading to go faster, e.g., by scrolling the text up/down automatically at the pace of the reader, or scrolling the text side-to-side in a wrapped form at the pace of the reader, such that the text/words would move rather than the eyes of the reader. The text can be presented such that the eyes are relieved from having to focus on words that are not likely to yield meaning (or are likely to slow down the reading rate), through font manipulations, gray scaling areas, and the like on words identified through speed reading and other techniques. Results from implemented speed reading and/or reading comprehension techniques may be stored on the electronic devices, and statistics related to a user's reading rate and/or reading comprehension can be determined and displayed on the electronic devices. While this disclosure may use terms for “graying,” “gray scaling,” or “grayed out” areas, those terms may also generally refer to the area outside of a windowed area of text that may be shaded, tinted, or partially obscured, for example, by any number of colors (e.g., blue, red, green, purple, etc.) or patterns (e.g., lines, grids, stripes, checkered blocks, watermarks, etc.) to help to focus the eyes of the reader on the text within the windowed area of text.

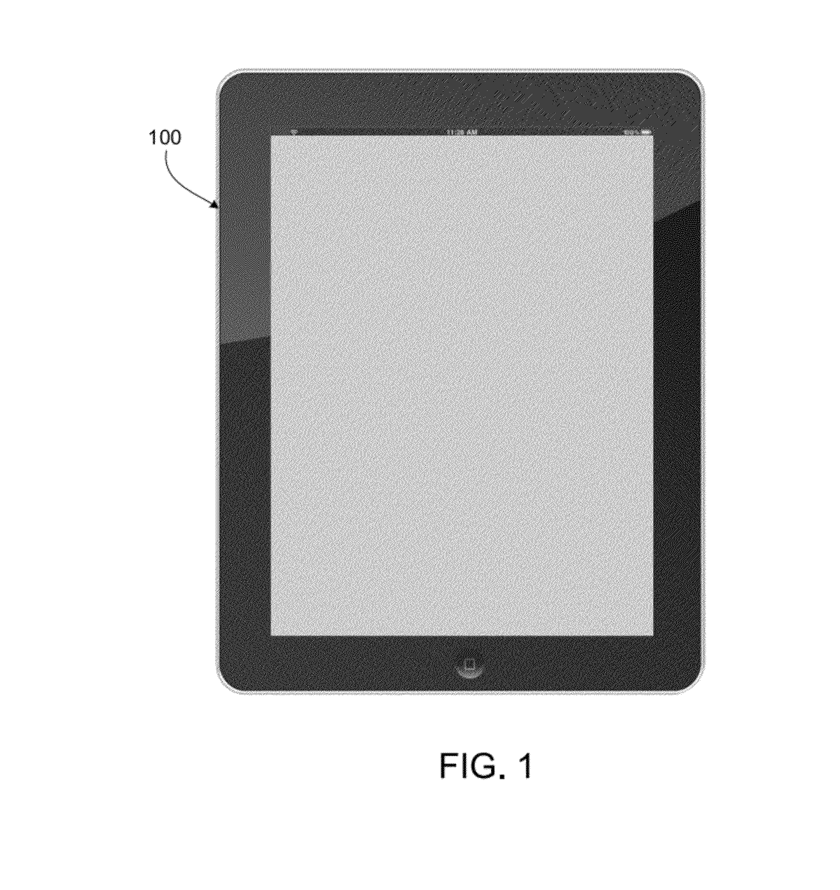

FIG. 1 depicts a diagram of an implementation of the speed reading and reading comprehension techniques on an electronic device 100. The electronic device 100 in FIG. 1 is a reading tablet or reading pad. The electronic device may be, for example, an “iPad” device from Apple Inc. of Cupertino, Calif., or a “Kindle” device from Amazon.com of Seattle, Wash. Other implementations of the speed reading and reading comprehension techniques can generally be implemented and presented on any electronic device that has a display for presenting text and other information, and some type of input (e.g., keyboard, mouse, trackpad, trackball, touch sensor, stylus, pointing device) that allows a user of the electronic device to input data or instructions for the implemented speed reading and reading comprehension techniques.

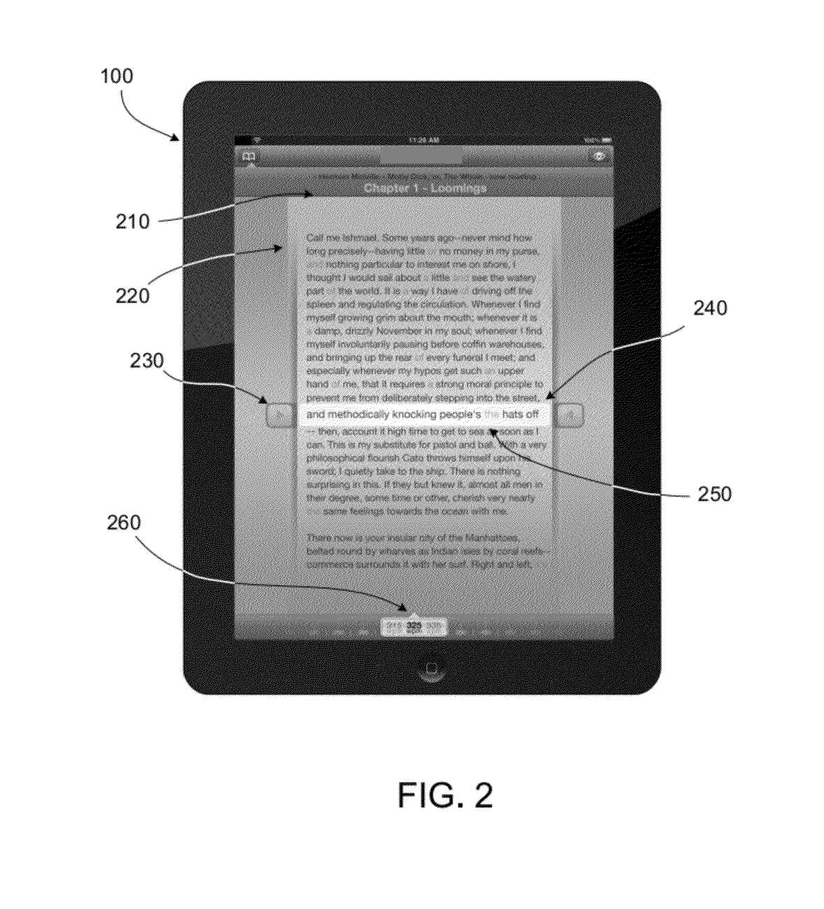

FIG. 2 depicts a diagram of text presented on the electronic device 100 with the implemented speed reading and reading comprehension techniques. The electronic device 100 has a display for presenting text in a framed area 220 in a graphical user interface. The electronic device 100 displays information 210 about the text that is being presented, such as the reading material, title, and author (e.g., Author: “Herman Melville;” Title: “Moby Dick;” “Chapter 1—Loomings”). The electronic device 100 displays the text in a grayed-out area and a windowed area 240 that is not grayed out. The text is presented in the framed area 220 of the graphical user interface, for which the entire framed area 220 is grayed out except for the windowed area 240. The windowed area 240 that is not grayed out includes markers 230 on the side of the windowed area 240 to allow the user to adjust the size of the windowed area 240. For example, the user may manipulate the markers 230 to adjust a number of lines that are included in the windowed area 240 (e.g., 1 line, 2 lines, 3 lines, 4 lines, or more) or even a width of the text area. In FIG. 2, the windowed area 240 is configured to present one line of non-grayed out text. In other implementations, two to five lines, for example, may be presented in the windowed area 240. In some implementations, another color may be used instead of a gray color. Generally, the area outside of the windowed area 240 within the framed area 220 of the graphical user interface may be shaded, tinted, shadowed or at least partially obscured by any number of colors or patterns to generally focus the eyes of the reader on the text within the windowed area 240. The electronic device 100 includes a word rate counter 260 at a bottom area of the display that shows how many words per minute (WPM) are being read by the user as the text scrolls down (or up). In FIG. 2, for example, the text is scrolling at a rate such that the user would have to read about 325 WPM to read the scrolling text content. The windowed area 240 also provides for one or more words or phrases within the windowed areas 240 to have text that is grayed out, for example, to allow the user to skim or skip over some words. For example, FIG. 2 shows that the word “the” is grayed out so that a user may skip a common article (e.g., “a,” “an,” “the”) when reading the text. For this example, the color of the font of the word may be changed to another color (e.g., gray, or a light color, such as a light shade of blue, tan, purple, or brown). The speed reading and comprehension techniques can be implemented in e-readers (e.g., as a downloadable application) or can be part of an essential, enabling technology for e-readers.

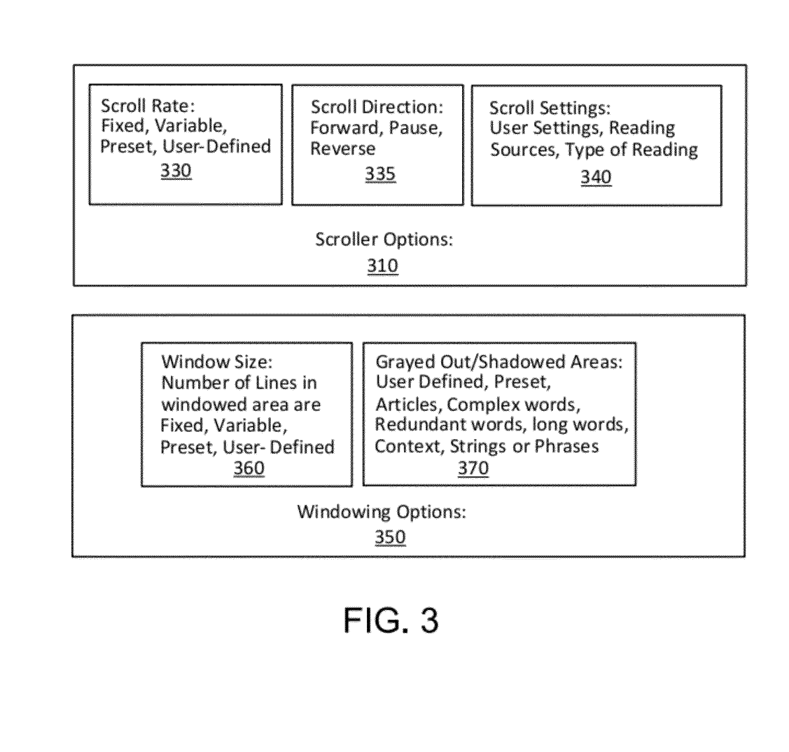

FIG. 3 depicts some of the options and configuration features for the speed reading and reading comprehension techniques. FIG. 3 shows some of the scroller options 310 and windowing options 350. The scroller options 310 include the scroll rate 330, the scroll direction 335, and/or the scroll settings 340. The windowing options 350 can involve the making adjustments in the windowed area size 360 and/or the grayed out or shaded areas 370.

The scroll rate 330 may be adjusted as part of a number of scroller options 310. For example, the user may use the input device to speed up or slow down the scroll rate. The user may define the scroll rate by inputting a value (e.g., “300” WPM) for the scroll rate in a user interface screen that is configured to receive a scroll rate input. The scroll rate may be fixed or varied. The scroll rate may be preset when the text begins to scroll. In some implementations, the software may allow the user to start reading at a slow speed, and then gradually adjust the scrolling rate upward until reaching his or her most comfortable reading rate. The scroll rate may be preset based on an age of the user (e.g., child, teenager, adult), the type of material (e.g., fantasy, novel, legal, scientific, scholarly journal articles). The scroll rate 330 may also be adjusted based on an adjustment to a selector indicator or an area of the display, such as the word rate counter 260, for example.

By allowing lines of words to scroll at the variable speed, for example, and by allowing the user to adjust the number of words per line, the user can focus their eyes on a fixed area of the display where words scroll past at a comfortable reading speed. In some implementations, by reducing or eliminating the need for a user's eyes to scan side-to-side while reading, it can be possible to increase an average rate of a reader's speed without affecting or diminishing the user's reading comprehension.

The scroll direction 335 may be in a forward direction, in a reverse direction, or paused to stop the scrolling text at a particular location of displayed reading material. The scroll settings 340 (e.g., scroll rate and direction) may be configured by a user to have user-defined settings, or the settings may be predefined. The user may be able to store their settings in the electronics device. The scroll settings may be individually defined for a user so that when a user enters their identification, their scroll settings are automatically loaded for reading the text. In some implementations, the scroll settings may be based on the type of reading material. For example, the user may select from amongst a number pre-defined scrolling speeds that are based on the reading material, such as “scan” for quick scanning of text, “novel” for fast pleasure reading, “technical” for dense legal or technical documents, “magazine” for newsstand-type magazines, or “websites” from articles on websites.

The windowed area size 360 can be varied. A windowed area size 360 can be placed around a number of lines in a windowed area of text. The windowed area can have a fixed number of lines, a variable number of lines, a preset/pre-defined number of lines, or a user-defined number of lines. For example, the windowed area can be defined by a user by user input for a specified number of lines, a number of words per line, or user manipulation of the size of a windowed area (e.g., graphical input or a user's finger movement on a touch screen), including a frame or a sub-frame related to the windowed area. The windowed area can help to keep the user focused on a small portion of the display to read quickly. By modifying the number of words per line, for example, the user can reduce or eliminate the side-to-side movement of the eye. The windowed area can have, for example, from about one to five lines to draw the user's eyes to the text of relevance. The windowed area may encompass multiple lines to encourage users to adjust the scroll speed to a comfortable reading rate, rather than the windowed area size.

The fast readers of printed text may read an entire line by focusing only on the center of the line and reading straight down the graphical user interface. The described implementations can allow the reader to set (and adjust at any time) the number of words per line so that their eyes do not need to move side-to-side (or down) when reading. As an example, a user might choose to display only a single word per line. As the lines scroll down, the reader's eyes can stay focused on a single point or area on the display. Over time, the user may increase the number of words per line, with the objective of being able to read longer lines with little to no side-to-side reading. In some implementations, the user can be able to select (and adjust) a font size of the text that is independent of the scroll rate and the number of words per line (with the understanding that certain combinations of font size and words per line may not be feasible given the limitations of the physical dimensions of the screen size of particular displays).

The windowing options 350 also include the use of grayed out or shaded areas of text. The areas that are not grayed out are the areas where the user's eyes should focus for reading as the text scrolls down the graphical user interface, whereas the grayed out areas are areas of the display of the text that are not within the windowed area so that those grayed-out areas are not focused upon by the reader. The software can provide the user with an option to gray-out articles (e.g., “a,” “an,” “the”) and other similar “invisible” words to deemphasize those words during reading. The reader may also able select any word, for example the long name of a character, and have all occurrences of that word grayed out in a similar fashion. The software can automatically or the user can manually gray out the article words, complex words, redundant words, long words, or words, strings or phrases that are difficult to pronounce. There could be several shades of gray available for the user to select, from very faint to almost black. There may also be an automated detection of words (e.g., each 8^{th} word). The context of the document may be taken into account. For example, in a legal context, some legal terms may be grayed out or made to stand out in the windowed area.

In some implementations, adjusting the windowing and scroller options 350, 310 may be useful, for example, in reading languages other than English. For example, some languages, like Hebrew and Arabic are read from right to left. The windowing around a number of lines in another language may help a non-native language speaker of that language to comprehend the language better, and in a shorter amount of time.

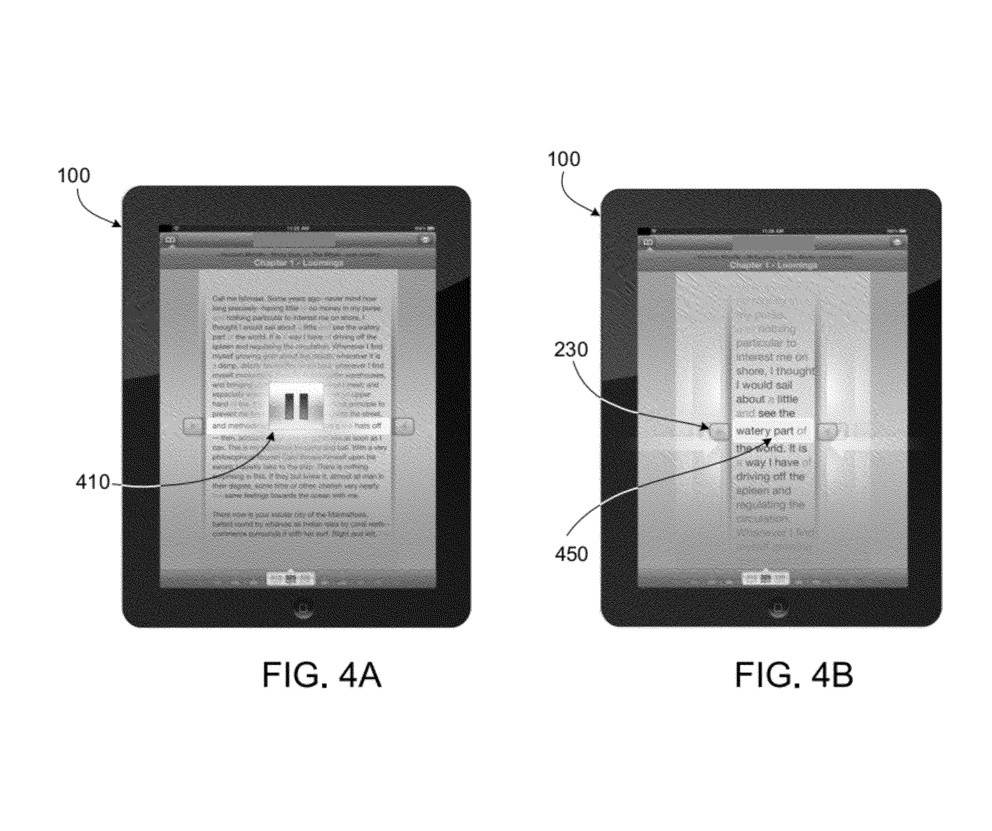

FIG. 4A depicts a diagram of the electronic device 100 when the scrolling of the text in the electronic device 100 is paused 410. Under the condition that the electronic device 100 is paused, the scrolling text in the display is halted. FIG. 4B depicts a diagram of a windowed area 450 in the electronic device 100, where parts of the text that are not within the windowed area 450 are grayed out. FIG. 4B also depicts an example where a width of the displayed text is narrowed from FIGS. 1-3 via the marker 230 by sliding the marker 230 inwards and towards the windowed area of text. In some implementations, when one end of the marker 230 is adjusted to move into the windowed area of text (or out of the windowed area of text) to compress (or stretch) the windowed area, the other end of the marker 230 may move in to (or out of) the windowed area by the same amount. In some implementations, for example, speed-reading can be achieved by a virtual flexible reading canvas, where the user can “pinch” the canvas with their fingers to narrow the windowed area to a band of two or more words that are animated in a scrolling manner within a “spotlight.” Conversely, the user can user their fingers to expand the reading area to a band of more than two words. The software can also have instructions such that the text can be intelligently gradated to highlight only the most important words. This effect, for example, can result in a reading experience that is focused on the contextual importance of the words and presented in a way so the reader does not have to move their head. The scroll speed can be adjustable and a simple touch to the screen can pause and start the scrolling.

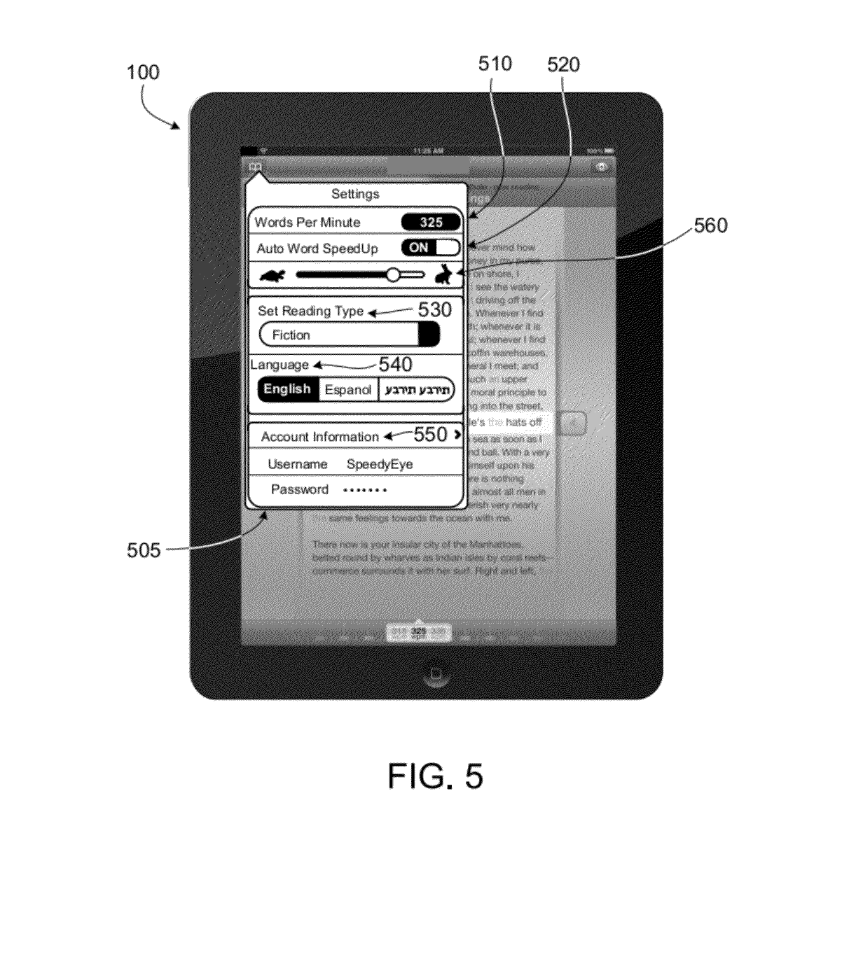

FIG. 5 depicts an example of the electronic device 100 with user settings and user account information. FIG. 5 shows, for example, a reader menu 505 that allows the user to personalize and fine tune their reading experience. The reader menu 505 includes controls to allow the user to set a number of words per minute 510, and allow the user to enable the automatic speeding up of their reading (auto word speedup 520) over time with a sliding bar 560. The reader menu 530 allows the user to set the type of reading material with an indicator to Set Reading Type 530. For example, the type of reading material in this situation is “Fiction” reading. The reader menu 530 allows the user to set their reading language in the electronic device 100, like English 540. The reader menu 505 may also include a section for account information 550 for a user to enter their username and password. The software can also display a number of instantaneous number of words per minute the reader is reading (based on the scroll rate and number of words per line), as well as a log of statistics over time.

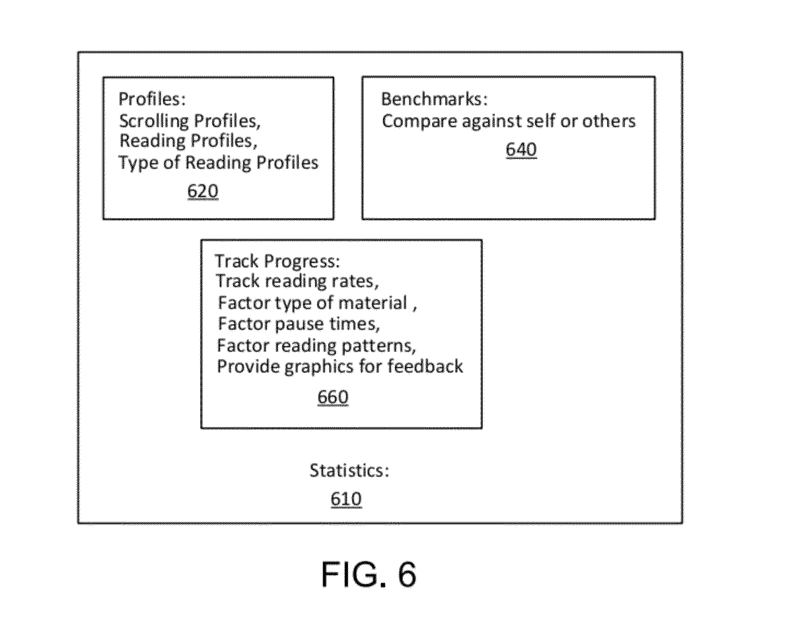

FIG. 6 depicts some of options and factors that are taken into account when utilizing statistics in the electronic device. The statistics can provide feedback to the user about the user's performance. As depicted in FIG. 6, profiles 620 are stored and used for scrolling profiles, reading profiles and the type of reading profiles. All of these profiles 620 may be part of a user's profile. Benchmarks 640 can be taken where results are compared against oneself, or compared with others. The software, when implemented, can have instructions to track their progress 660 by tracking their reading rates, factoring the type of reading materials (e.g., websites, magazine articles, novels), and factoring in the pause times (e.g., times that the strolling stopped or was halted) when computing the results. The statistics 610 can involve factoring reading patterns, and providing graphical results to provide visual feedback to the user on their progress.

In some implementations, there can be scrolling profiles and reading profiles that can be created and saved for individual users of the electronic device. The software can allow the user to set and save different scrolling profiles on their electronic devices for different types of reading. In one example, a profile can be set to allow a user to ramp up a rate of their speeding as they begin reading the text. For example, for a work of fiction, the first page from the source of reading material can be set to be read at 200 WPM, the second page from the source of reading material can be set to 300 WPM, and the third page from the source of reading material can be set to 400 WPM. In another example, a work of non-fiction may have the pages set at a fixed, slower rate than the work of fiction. In some implementations, the reading rate can be based on a number of words of text and/or a number of lines of text that is presented in the windowed area in a time interval (e.g., one minute or one hour). In some implementations, input for generating the statistics may be determined by the software, and in other implementations, the statistics may be manually entered by the user. In some implementations, the reading rate may be set to the average reading rate of a person at a certain age based on an average reading profile. For example, average profiles of readers of certain ages or grade levels can be stored in the electronic device and used as a pre-determined reading rate for the user when matched to the user's age or grade level. In this example, the user may not want to individually guess their reading rate, and but just use the average reading rate based on their skill level, age, or grade level, for example.

In regards to the benchmarks 640, the software can be configured to allow various users to benchmark their reading speed and comprehension progress with others, and as well to allow them to benchmark their progress against results based on an average reading profile (based on the user's averages or the averages of other readers). The various users can share their data, which can be downloaded (via a server) onto one or more of the electronic devices. A user can benchmark their reading results against the reading speed and comprehension results of others, such as celebrities, co-workers, classmates or family members, for example.

The use of statistics 610 in the software can also allow users to track their progress 660. For example, users can track their reading rates and see improvements in their reading speed over a length of time (e.g., a few weeks, several months, or longer). The software can utilize a processor in the electronic device to compute and show statistics to the user that relate to developments and improvements in their reading rate and comprehension. The software can take into account the type of material (e.g., web page, email, novel, technical/legal, magazine article), and track how the user's reading rates vary over the length of time depending on the type of material that is read. The software can factor out the pause times to track an amount of time of continuous (non-paused) reading for the user. The software can also take into account and determine the starting, plateau, and finishing reading rates of reading for the user for various types of reading materials. For example, the starting reading rate may be the initial reading rate over a beginning section of reading material (e.g., anywhere from a few paragraphs to a few pages of reading material), the plateau reading rate may be a reading rate of the reader over most of the reading material, and a finishing rate may be a reading rate near the end of the reading material (e.g., anywhere from a few paragraphs to a few pages of the reading material near the end of the reading material). There can also be various links (e.g., hyperlinks) embedded in the reading material that can allow the user to select one or more links to jump to other reading material. The software also can track the reading rate of the user if the user elects to jump to the other reading material. The software can track the rates at which the user reads over a length of time. For example, the software can track the reading rate of the user over short amounts of time (e.g., three minutes), and compare that reading rate of the user over longer amounts of time (e.g., one hours), and present that information in the display of the electronic device. The comparison of reading rates over different amounts of time, for example, can reveal information to the user about their attention span in reading the material. In some implementations, for example, the source material may be email, for which the email may be ported from, or copied from, linked to, or used within an email application, such as Microsoft Outlook by Microsoft Corporation of Redmond, Wash., or some other web-based email application.

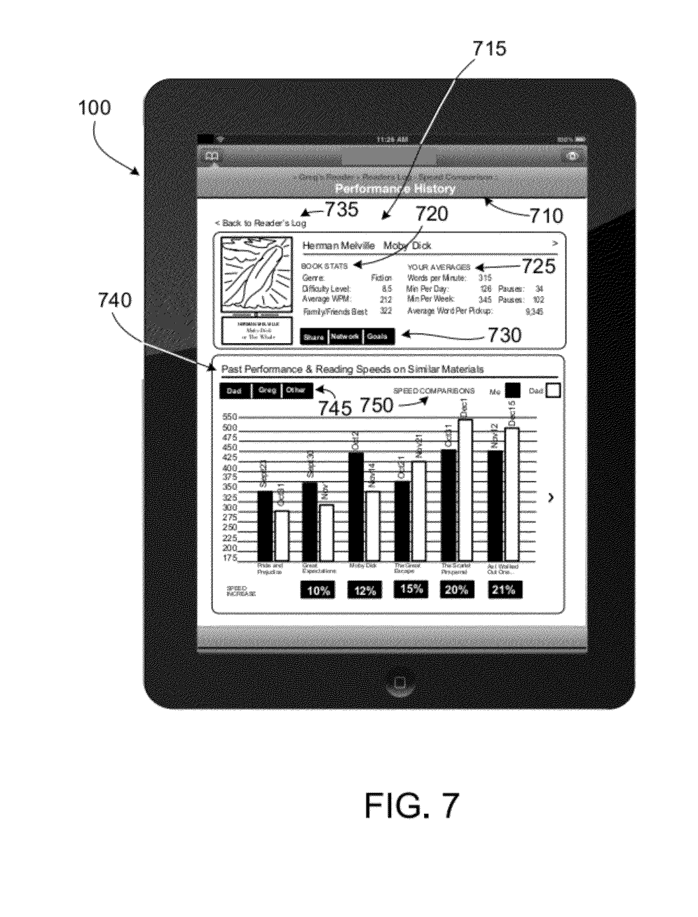

FIG. 7 depicts an example of the electronic device 100 where statistics are used to allow the user to record and review results of their reading rate and comprehension. The electronic device 100 has software that is configured to present information regarding the performance history 710 of a user (e.g., “Performance History” on the electronic device for “Greg's Reader” in a “Reader's Log” for a “Speed Comparison”). In the example shown in FIG. 7, the software takes a log of the user (e.g., “Greg”) in a “Reader's Log” section 735, which provides statistics for the user's reading rate and reading comprehension for various types of reading materials. For example, FIG. 7 shows that for the reading material 715 for the book “Moby Dick” by “Herman Melville,” book statistics 720 are taken into account and shown to the user. The book statistics 720 include a genre of the reading material (e.g., fiction book), a difficulty level of the reading material (e.g., 8.5 on a scale of 1 to 10), an average rate that the reading material read by an average reader (e.g., 212 wpm for an average reader), an average rate that others (e.g., family friends) have read the reading material (e.g., 322 wpm). The software can also track and present information regarding the user of the software, for example, for user interactions with the reading material. For example, some average statistics 725 (e.g., “Your Averages”) are kept on the user, such as an average rate of the words per minute, an average of a number of minutes per day spent reading the reading material, an average for a number of minutes per weeks spent reading the reading material, an average number of pauses taken per day when reading the reading material, average number of pauses taken per week when reading the reading material, and an average number of words that are read per reading session (e.g., the amount of time between when the user begins to read to when the user stops reading the reading material, which may or may not account for pauses).

The software may be configured on the electronic device 100 to share the statistics from various users of the software with a server and a storage system that stores and keeps track of statistics of various types of reading materials and/or software users. The server and storage system may be maintained by an entity that can also provide the software to the various electronic devices. The software has indicators 730 that can allow the user to “share” their reading statistics with other software users, to “network” with other software users to receive their reading information, as well as to interchange their reading “goals” (e.g., a goal of reading 400 wpm).

The software can graphically present reading statistics related to the user and other users. For example, FIG. 7 shows graphical results 740 related to a past performance and reading speeds on materials that are similar to those of the current reading material. The software can maintain information regarding various readers (e.g., “Greg,” “Dad,” “Others”), and can graphically provide a selector 745 to allow the user to select amongst various readers to have their reading information presented in the display of the electronic device. The graphical statistical reading information can include reading rate comparisons 750 between various users, which can reveal changes (and increases) in reading rates (e.g., “speed increase” 760).

At any point when using the software (e.g., during reading the reading material), the user can access a statistics page (e.g., a Reading Log/Stats page) to see how their performance, obtain tips on how to set their settings for reading improvements, set goals, obtain and view past performances and compare their statistics to the statistics of others.

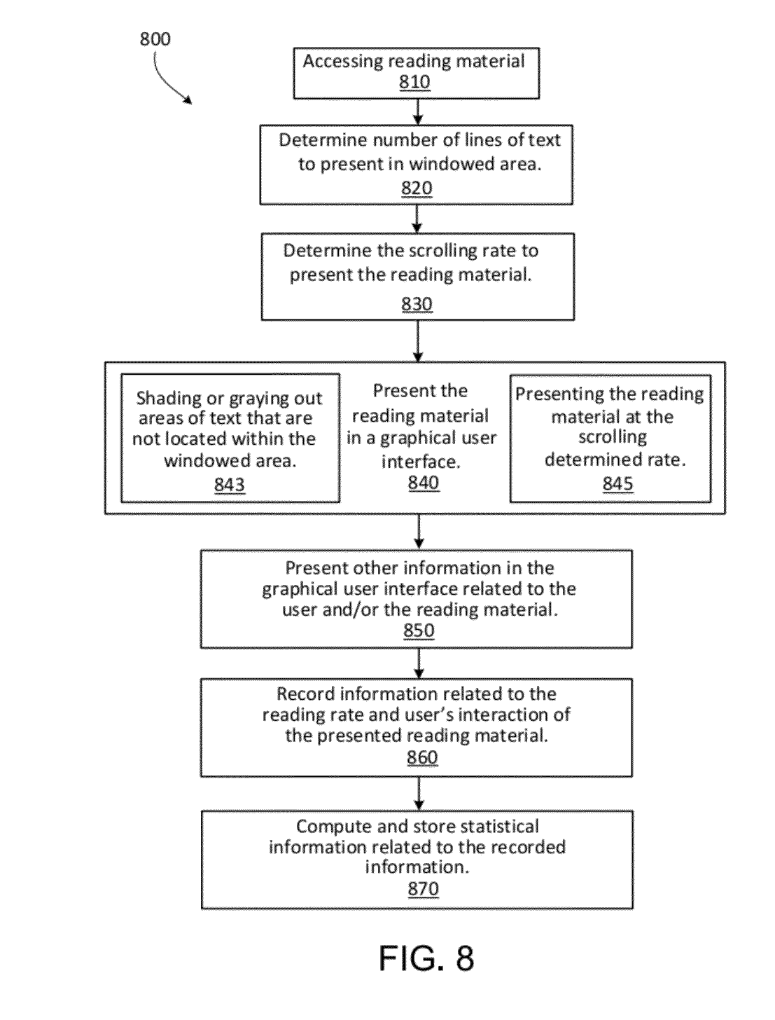

FIG. 8 depicts an example of a flow diagram 800 for an implementation of the speed reading and reading comprehension techniques on the electronic device. In the flow diagram 800, the reading material is loaded or accessed (810) by the software for the speed reading and reading comprehension. The number of lines of text to present in the windowed area is determined (820). The number of lines of text can be determined as in the methods described above. The scrolling rate to present the reading material is determined (830). The scrolling rate can be determined as in the methods described above. The reading material is presented in the graphical user interface (840). In presenting the reading material, the areas of text of reading material that are not in the windowed area are grayed out (843), and the reading material begins to be presented in the graphical user interface at the determined scrolling rate (845). Generally, the area outside of the windowed area may be shaded, tinted, or at least partially obscured by any number of colors or patterns to help to focus the eyes of the reader on the text within the windowed area 240. Other information, such as information related to the user or reading material as described above, is presented in the graphical user interface (850). Information related to the reading rate and the user's interaction with the presented reading material is recorded (860). The statistical information related to the recorded information is computed and stored (870).

Software relating to techniques for employing speed reading and reading comprehension concepts on electronic devices can be implemented in various methods. For the example, the software may be configured as a stand-alone application, which can be implemented on a personal computer, a reading tablet, or a mobile device, for example. The stand-alone application could have the ability to import text from many common file formats (including Hypertext Markup Language (HTML), Microsoft Word by Microsoft Corporation of Redmond, Wash., Adobe Acrobat PDF by Adobe Systems Incorporated of San Jose, Calif., Google Docs of Google Incorporated of Mountain View, Calif., an electronic clipboard, etc.) and display that text within the application, thus providing software controls for the implemented speed reading and reading comprehension functions.

The software may be configured as a browser plug-in, which can be implemented on a personal computer, a reading tablet, or a mobile device, for example. In the same or similar way that many Web pages allow the user to select a “printer friendly” version of an article, a plug-in could allow the user to select a “speed reader” version of the article. The text could then be displayed in a new browser window that uses Ajax or similar controls to implement the functionality described above. Alternately, the plug-in could allow the user to select a “print to speed reader” option, which could then export the text to a digital format that could be read by the stand-alone speed reading application.

The software can be configured as an electronic reader (e-reader) native application. For example, e-reader devices such as the Amazon Kindle from Amazon.com, Sony E-Reader from Sony of Tokyo, Japan, and the Barnes & Noble Nook of Barnes & Noble of New York, N.Y., could implement the functionality within the native software application, through extensions to the native software application, or through a third-party software application that could be loaded onto the electronic device. In the case of dedicated e-readers, for example, some of the functional controls (e.g., the scroll rate) could have inputs for physical hard keys, buttons or scroll dials rather than software and soft keys.

In some implementations, a “page” of text may refer to a frame of text in a graphical user interface, a screen area of the graphical user interface, a size of a screen area, an allowable, predetermined, or desired number of words of text and/or lines of text in the frame or the screen area, or a combination of them. In some implementations, a “page” of text may be determined based on the source of the reading material (e.g., a printed page of the source material, such as a page from a book, magazine, journal, or some other writing), a corresponding printed page of text on a sheet of paper, or the display that the text is presented upon. In some implementations, the number of words or lines per minute for the reading rate may be determined by receiving instructions for characteristics of the page (e.g., related to the reading source, the electronic reading device, preset conditions stored in a file or in memory, or from user input). In some implementations, measurements may be taken to determine a number of pages that are read (or scrolled in the windowed area or framed area) in a time interval.

Some of the described embodiments of the subject matter and the operations can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be useful.

What is claimed is:

1. A method for providing speed reading or reading comprehension capabilities on an electronic device for one or more users, the method comprising:
accessing reading material comprising text on the electronic device, wherein the electronic device comprises a display;
accessing a graphical user interface to present the reading material;
determining a number of lines of text to present within a windowed area within the graphical user interface; and
presenting the reading material in the graphical user interface on the display of the electronic device,
wherein:
an area in the graphical user interface that is located outside of the windowed area is grayed, shaded or partially obscured,
the text of the reading material is presented both within the windowed area and outside of the windowed area, and
the text within the area located outside of the windowed area is grayed, shaded or partially obscured.

2. The method of claim 1, further comprising:
determining a scrolling rate to present the reading material; and
presenting the reading material at the determined scrolling rate, wherein the material is scrolled in a direction that presents one or more lines of text at a time in the windowed area.

3. The method of claim 2, further comprising:
accessing information related to the reading material, wherein the other information comprises at least an author of the reading material.

4. The method of claim 2, further comprising:
tracking one or more user interactions related to the reading material on the electronic device; and
recording the tracked one or more user interactions.

5. The method of claim 2, wherein the user interactions comprises information for a length of time the reading material scrolls on the graphical user interface until the scrolling is stopped, a length of time the reading material scrolls on the graphical user interface before the scrolling is paused, a rate of words per minute that are presented in the graphical user interface, a number of pauses that occurs within a first time interval, or a number of times the scrolling of the reading material is stopped or restarted in the graphical user interface.

6. The method of claim 5, wherein the user interactions further comprise receiving instructions for a rate of words per minute to present in the graphical user interface in a second time interval, receiving instructions for a rate of words per minute to present in the windowed area in a third time interval, information for a time and a date the reading material is presented in the graphical user interface, or user information associated with the reading material or the electronic device.

7. The method of claim 6, further comprising:
recording information related to the user interactions; and
computing statistics related to the recorded information.

8. The method of claim 7, further comprising:
storing the computed statistics on the electronic device; and
sharing at least some of the computed statistics with at least a server or at least one other computer that is separate from the electronic device;
wherein the sharing comprises:
retrieving the stored computed statistics on the electronic device; and
sending the retrieved computed statistics to at least the server or at least the one other computer.

9. The method of claim 8, further comprising:
receiving a request for the computed statistics;
retrieving the computed statistics on the electronic device; and
presenting the computed statistics on the graphical user interface of the electronic device.

10. The method of claim 9, further comprising:
receiving a request for statistics related to speed reading or reading comprehension for another user who is different from a current user of the electronic device;
providing the statistics related to the user in the graphical user interface;
providing the statistics related to the other user in the graphical user interface; and
providing a selector in the graphical user interface that, upon being selected, is configured to present a comparison of the statistics related to the user and the other user in the graphical user interface.

11. The method of claim 2, wherein the number of lines of text to be presented in the windowed area is configured to be determined by at least one of:
a user input for the number of lines,
a number of lines that is preset in a memory location in the electronic device, or
a user's manipulation of a marker on the graphical user interface that is configured to adjust the number of lines in the windowed area.

12. The method of claim 2, further comprising:
presenting a word rate counter in the graphical user interface that shows a number of words per minute presented in the graphical user interface.

13. The method of claim 12, wherein the word rate counter is configured to receive a user input to set the number of words per minute presented in the graphical user interface.

14. The method of claim 2, further comprising:
receiving an instruction to scroll the text in the graphical user interface in a first direction downwards towards an end of the reading material, in a second direction upwards to a beginning of the reading material, or to pause or stop scrolling the reading material in the graphical user interface.

15. The method of claim 2, wherein the scrolling rate is configured to be a fixed scrolling rate or a variable scrolling rate.

16. The method of claim 2, wherein the scrolling rate varies for different parts of the reading material.

17. The method of claim 2, wherein the scrolling rate is determined based on an age of the user of the electronic device, a type of the reading material, a complexity of the reading material, or a recently-used scrolling rate.

18. The method of claim 2, wherein the scrolling rate is determined based on a user-defined scrolling rate.

19. The method of claim 2, further comprising:
selecting one or more words that appear from the text within the windowed area to gray, shade, tint, deemphasize or partially obscure, wherein the one or more grayed, shaded, tinted, deemphasized or partially obscured words include a word that is an article, a commonly-used word in the text, a word that has a word length exceeding a number of characters, or a word that is selected by a user to be grayed, shaded, tinted, deemphasized or partially obscured.

20. The method of claim 1, further comprising:
retrieving account information for a user;
presenting the account information in the graphical user interface; and
presenting information in the graphical user interface related to at least a reading rate of the user over one or more time intervals.

21. The method of claim 1, further comprising:
retrieving account information for multiple users;
presenting the account information in the graphical user interface; and
presenting information in the graphical user interface related to at least a reading rate of the multiple users over one or more time intervals, wherein the presented information comprises at least a comparison of information for at least two of the users.

22. The method of claim 1, further comprising wherein the reading material is accessed from an email.

23. An article comprising a non-transitory machine-readable medium storing instructions operable to cause a machine to perform operations for providing speed reading or reading comprehension capabilities on the machine for one or more users, the article having the instructions comprising:
accessing reading material comprising text on the electronic device, wherein the electronic device comprises a display;
accessing a graphical user interface to present the reading material;
determining a number of lines of text to present within a windowed area within the graphical user interface; and
presenting the reading material in the graphical user interface on the display of the electronic device,
an area in the graphical user interface that is located outside of the windowed area is grayed, shaded or partially obscured,
the text of the reading material is presented both within the windowed area and outside of the windowed area, and
the text within the area located outside of the windowed area is grayed, shaded or partially obscured.

24. The article of claim 23, further comprising instructions to:
determine a scrolling rate to present the reading material; and
present the reading material at the determined scrolling rate, wherein the material is scrolled in a direction that presents the determined number of lines of text in the windowed area.

25. The article of claim 23, further comprising instructions to:
record information related to a user's interaction with the reading material on the graphical user interface, wherein the recorded information comprises at least an assessment related to a user's reading rate of reading the reading material;
compute statistics related to the recorded information for providing at least the assessment for at least the reading rate of the user, comparing two or more reading rates of the user over different time intervals, or comparing at least a reading rate of the user with a reading rate of another user; and
present the computed statistics on the graphical user interface.

26. The article of claim 25, further comprising instructions to:
store a reading profile of the user, wherein the reading profile of the user comprises at least a previously-used reading rate or a pre-defined reading rate for the user based on at least a type of reading material or an age of the user;
share the reading profile with at least one other user by transmitting the reading profile of the user to an electronic device that permits the other user to access the reading profile of the user;
receive a reading profile of the other user; and
present information related to the reading profiles of the user and the other user on the graphical user interface.

27. A method for providing speed reading functionality on an electronic device for one or more users, the method comprising:
loading reading material on the electronic device, wherein the electronic device comprises a display configured to present the reading material in a graphical user interface, wherein the reading material comprises multiple lines of text;
scrolling the one or more lines of text of the reading material in a direction in the graphical user interface;
determining a number of words that are scrolled in the graphical user interface in a time interval;
using the determined number of words scrolled in a time interval to determine a reading rate for a reader of the reading material;
presenting the reading rate for the reader in the graphical user interface;
presenting one to five lines of the text in a windowed area within the graphical user interface; and
shading, tinting, deemphasizing or at least partially obscuring the text that is not within the windowed area such that the text within the windowed area is more predominately displayed in the graphical user interface than the text outside of the windowed area.

28. The method of claim 27, further comprising:
storing the reading rate for the reader in the electronic device, wherein the stored reading rate is associated with the reading material or with a type of reading material that is similar to the reading material in the graphical user interface, wherein the type of reading material is classified according to at least a web page, a journal article, a legal publication, a technical publication, a type of book, an email, a complexity of the reading material or an age group for readers of the reading material.

29. The method of claim 27, further comprising:
maintaining information for a user account for the reader, wherein the user account comprises one or more preferences provided by the user regarding a selected reading material, a type of reading material or a pre-defined number of words for a time interval to scroll the reading material in the graphical user interface, wherein the user account further comprises information regarding a log of reading materials that have been accessed by the user, a log of one or more reading rates associated with the reading materials, or statistics related to the one or more reading rates associated with changes in the one or more reading rates over one or more time intervals.

30. A method for providing speed reading or reading comprehension capabilities on an electronic device for one or more users, the method comprising:
accessing reading material comprising text on the electronic device, wherein the electronic device comprises a display;
accessing a graphical user interface to present the reading material;
determining a number of words per line of text to present within a windowed area within the graphical user interface;
determining a number of lines of text to present within the windowed area within the graphical user interface; and
presenting the reading material in the graphical user interface on the display of the electronic device,
wherein:
the windowed area is located within a framed area within the graphical user interface,
an area in the graphical user interface that is located outside of the windowed area and within the framed area is grayed, shaded or partially obscured,
the text of the reading material is presented within the framed area,
the text of the reading material is presented within the windowed area and outside of the windowed area within the framed area, and
the text within the area located outside of the windowed area and within the framed area is grayed, shaded or partially obscured.

31. The method of claim 30, wherein the reading material is accessed from an email.

32. The method of claim 30, further comprising:
scrolling the text in the windowed area; and
determining a number of words scrolled into the windowed area in a time interval.

33. The method of claim 30, further comprising receiving instructions for a rate to scroll the text in the windowed area.

34. The method of claim 30, further comprising receiving user instructions for manipulating a size of the windowed area to change the number of words per line or the number of lines of text in the windowed area; and
changing the number of words per line or the number of lines of text in the windowed area corresponding to the user instructions.

35. The method of claim 34, wherein the user instructions are received via one or more user interactions on a touch screen device, wherein the interactions relate to a user adjusting the size of the windowed area or a size of the framed area around the windowed area.

36. The method of claim 30, further comprising accessing instructions for one or more words, phrases, or a string of text to gray, shade or at least partially obscure within the windowed area.

37. The method of claim 36, wherein a font of the one or more words, phrases, or the string of text is grayed, shaded, de-emphasized or at least partially obscured within the windowed area according to the accessed instructions.

38. The method of claim 30, wherein presenting the reading material in the graphical user interface on the display of the electronic device comprises presenting the reading material on a tablet reading device comprising a touch screen that is configured to receive user instructions.
